(19) United States
(12) Patent Application Publication
(10) Pub. No.: US 2022/0377576 A1
(43) Pub. Date: Nov. 24, 2022

(54) WIRELESS COMMUNICATION SYSTEM, WIRELESS COMMUNICATION APPARATUS, AND WIRELESS COMMUNICATION METHOD

(71) Applicant: NIPPON TELEGRAPH AND TELEPHONE CORPORATION, Tokyo (JP)

(72) Inventors: Tatsuhiko IWAKUNI, Musashino-shi, Tokyo (JP); Daisei UCHIDA, Musashino-shi, Tokyo (JP); Shuki WAI, Musashino-shi, Tokyo (JP); Naoki KITA, Musashino-shi, Tokyo (JP)

(73) Assignee: NIPPON TELEGRAPH AND TELEPHONE CORPORATION, Tokyo (JP)

(21) Appl. No.: 17/773,884

(22) PCT Filed: Nov. 15, 2019
(86) PCT No.: PCT/JP2019/044871

§ 371 Date: May 3, 2022

(51) Int. Cl. H04W 16/28; H04W 24/10; H04W 76/10

(52) U.S. Cl. CPC H04W 16/28; H04W 24/10; H04W 76/10

(57) ABSTRACT

A wireless communication system has a communication control device and a plurality of wireless communication devices. The communication control device transmits, to one of the wireless communication devices, information regarding a measurement target device that is another one of the wireless communication devices with which interference power is to be measured. Each of the wireless communication devices includes a wireless unit, a power measurement unit, and a communication control unit. The wireless unit forms a beam and transmits and receives a wireless signal using the formed beam. The power measurement unit measures power of a wireless signal received by the wireless unit. The communication control unit performs processing for controlling the wireless unit so as to establish a second wireless communication link with a measurement target device using a beam for a first wireless communication link, and processing for controlling the power measurement unit so as to measure power of a wireless signal received from the measurement target device when establishing the second wireless communication link.

### TECHNICAL FIELD

The present invention relates to a wireless communication system, a wireless communication device, and a wireless communication method.

### BACKGROUND ART

Wireless communication in unlicensed bands using millimeter waves, typified by IEEE802.11ad, has advantages over the conventional microwave band in that a wider band can be secured, and higher linearity and less interference to other communication can be achieved, for example. The spread of wireless communication using millimeter waves have been examined for those advantages (e.g., see NPL 1).

The amount of distance attenuation in wireless transmission paths increases in accordance with the frequency. Further, the 60 GHz band, such as that used in IEEE802.11ad, is affected by oxygen absorption. For these reasons, it is common in the communication in the millimeter wave band to form a directional beam (beamforming) toward a terminal device that is a communication partner and transmit and receive signals.

FIG. 7 is a conceptual diagram of a communication system that uses beamforming in a general millimeter wave band. FIG. 7 shows two wireless communication devices 90. An i-th (i is an integer of 1 or more) wireless communication device 90 is referred to as a wireless communication device 90-i. In FIG. 7, i=1, 2. The wireless communication device 90-i selects a beam B90-nᵢ (nᵢ is an integer of 1 or more and N or less) that maximizes the received power on a receiving station side from among beams B90-1 to B90-N (N is an integer of 2 or more), which are directional beams that the wireless communication device 90-i can form. Note that the shape of each of the beams B90-1 to B90-N(N is an integer of 2 or more) and the value of N may differ depending on the wireless communication device 90. Further, as shown in FIG. 9, the wireless communication device 90 can commonly form a beam B90-Z that maximizes the beam width, in addition to the beams B90-1 to B90-N(N is an integer of 2 or more) that are directional beams to be used in communication. The beam B90-Z of the wireless communication device 90-i is referred to as a beam B90-Zi.

In IEEE802.11ad, beam selection is performed in accordance with a procedure called SLS (Sector Level Sweep) (e.g., see NPL 2). The beam selection procedure will be described while taking, as an example, the case where an initiator that initiates communication is the wireless communication device 90-1, and a responder that opposes the initiator is the wireless communication device 90-2. First, the initiator sequentially transmits a signal using each of the candidate beams B90-1 to B90-N. At this time, the responder receives a signal transmitted using the beam B90-Z₁ with the largest beam width, and measures the received power of the signal. Next, the responder sequentially transmits a signal using each of the possible candidate beams B90-1 to B90-N. The initiator receives a signal with the beam B90-Z₂ with the largest beam width, and measures the received power of the signal. Then, the initiator and the responder share the ID of the beam with which the largest received power was obtained. The beam selection is completed by this procedure.

To effectively use wireless resources, a wireless communication device simultaneously transmits a large amount of data in a high SNR (Signal-to-Noise Ratio) environment. Conversely, in a low SNR environment, a wireless communication device suppresses the amount of data to be simultaneously transmitted and maintain a low error rate. Thus, adaptive modulation for changing the modulation method in accordance with the situation of the transmission path is also performed commonly. To select an optimal modulation method, a receiving station needs to feed back the received power of a received signal to a transmitting station. For these reasons, a wireless communication device commonly has a mechanism for measuring power of a received signal.

Meanwhile, in Japan, there are only four communication channels that can be used in IEEE802.11ad. Thus, the effective use of frequency resources is also one of the issues in the millimeter wave band.

FIG. 8 is a diagram showing a wireless communication system in which a plurality of wireless communication links are set up. In FIG. 8, pairs of wireless communication devices 90 communicate while setting up respective wireless communication links therebetween using the millimeter wave band in the same space. Each of the wireless communication devices 90 uses, for the wireless communication link, a beam B90-n (n is an integer of 1 or more and N or less) selected from among beams B90-1 to B90-N (N is an integer of 2 or more), which are directional beams that the wireless communication device 90 can form. The values of N and n may differ depending on the wireless communication device 90.

In the case of the wireless communication system shown in FIG. 8, the wireless communication devices 90 that constitute each wireless communication link need to accurately ascertain interference power received from other wireless communication devices 90. In addition, optimization of wireless communication resources over the entire space, such as transmission power control and frequency allocation for each wireless communication device 90, is required to minimize interference. In FIG. 8, a communication control device 91 is wired-connected to one of two wireless communication devices 90 that constitute each link. A control unit 92 of the communication control device 91 performs communication control for the wireless communication devices 90 for the purpose of optimizing the entire space.

To directly measure the interference power in a wireless communication device, it is necessary to add a mechanism for measuring the interference power, i.e., incorporating a dedicated measurement circuit, resulting in an increase in the device cost. Meanwhile, as previously mentioned, a common wireless communication device has a mechanism for measuring received signal power itself for the purpose of beam selection and adaptive modulation. It is not impossible to measure interference power using this mechanism, but there are the following two problems.

The measurement mechanism for beam selection in 11ad has a configuration in which either one of the wireless communication devices receives signals with the large beam width. That is to say, the value of interference power measured by this measurement mechanism is not accurate because the situation is different from that during communication. This is the first problem. In addition, to acquire measured power in adaptive modulation, it is necessary to attempt to also connect once to a wireless communication device that is an interference source. For this attempt, beamforming is performed for the wireless communication device that is the interference source. Accordingly, it is possible to measure only the interference power under the conditions under which communication is actually performed with a desired wireless communication device, i.e., the conditions different from the conditions under which a beam is formed for a desired wireless communication device that is a communication partner. This is the second problem.

### CITATION LIST

### Non Patent Literature

[NPL 1] Takinami et. al, “Standardization Trends and Elemental Technologies of Millimeter Wave Wireless LAN System”, Communication Society Magazine, Institute of Electronics, Information and Communication Engineers, 2016, 2016 Autumn Issue, No. 38, p. 100-106
[NPL 2] IEEE, “Part 11: Wireless LAN Medium Access Control (MAC) and Physical Layer (PHY) Specifications Amendment 3: Enhancements for Very High Throughput in the 60 GHz Band”, 9.35 DMG beamforming, IEEE Std 802.11ad-2012, 2012, p. 278

### SUMMARY OF THE INVENTION

### Technical Problem

As mentioned above, it is difficult for a wireless communication device that performs beamforming to accurately ascertain interference power received from other wireless communication devices in a state where the wireless communication device that performs beamforming has formed a beam toward an opposing wireless communication device that is a communication partner. If the interference power received by the wireless communication link cannot be accurately ascertained, it may be difficult to optimize wireless communication resources over the entire space.

In view of the foregoing circumstances, an object of the present invention is to provide a wireless communication system, a wireless communication device, and a wireless communication method with which interference power received by a wireless communication link can be ascertained more accurately.

### Means for Solving the Problem

One aspect of the present invention is a wireless communication system that has a communication control device and a plurality of wireless communication devices, the communication control device including a control unit for transmitting, to one of the wireless communication devices, information regarding a measurement target device, which is another one of the wireless communication devices with which interference power is to be measured, and each of the wireless communication devices including: a wireless unit for forming a beam and transmitting and receiving a wireless signal using the formed beam; a power measurement unit for measuring power of a wireless signal received by the wireless unit; and a communication control unit for performing processing for controlling the wireless unit so as to establish a second wireless communication link with the measurement target device using a beam for a first wireless communication link, and processing for controlling the power measurement unit so as to measure power of a wireless signal received from the measurement target device when establishing the second wireless communication link.

One aspect of the present invention is a wireless communication device including: a wireless unit for forming a beam and transmitting and receiving a wireless signal using the formed beam; a power measurement unit for measuring power of a wireless signal received by the wireless unit; and a communication control unit for performing processing for receiving information regarding a measurement target device that is a wireless communication device with which interference power is to be measured and controlling the wireless unit so as to establish a second wireless communication link with the measurement target device using a beam for a first wireless communication link, and processing for controlling the power measurement unit so as to measure power of a wireless signal received from the measurement target device when establishing the second wireless communication link.

One aspect of the present invention is a wireless communication method for use in a wireless communication system that has a communication control device and a plurality of wireless communication devices, the method including: a transmission step of transmitting, to one of the wireless communication devices, information regarding a measurement target device that is another one of the wireless communication devices with which interference power is to be measured, with use of the communication control device; a wireless communication step of forming a beam and transmitting and receiving a wireless signal using the formed beam, with use of a wireless unit of the one of the wireless communication devices; a power measurement step of measuring power of a wireless signal received by the wireless unit, with use of a power measurement unit of the one of the wireless communication devices; and a communication control step of performing processing for controlling the wireless unit so as to establish a second wireless communication link with the measurement target device using a beam for a first wireless communication link, and processing for controlling the power measurement unit so as to measure power of a wireless signal received from the measurement target device when establishing the second wireless communication link, with use of a communication control unit of the wireless communication device.

### Effects of the Invention

According to the present invention, it is possible to more accurately ascertain interference power received by a wireless communication link.

### BRIEF DESCRIPTION OF DRAWINGS

FIG. 1 is a diagram showing a configuration of a wireless communication system according to a first embodiment of the present invention.

FIG. 2 is a diagram showing a configuration of the wireless communication device of the first embodiment.

FIG. 3 is a diagram showing a configuration of the wireless communication device of the first embodiment.

FIG. 4 is a flowchart showing operations of the wireless communication system according to the first embodiment.

FIG. 5 is a diagram showing a configuration of a wireless communication system according to a second embodiment of the present invention.

FIG. 6 is a flowchart showing operations of the wireless communication system according to the second embodiment.

FIG. 7 is a conceptual diagram of a wireless communication system.

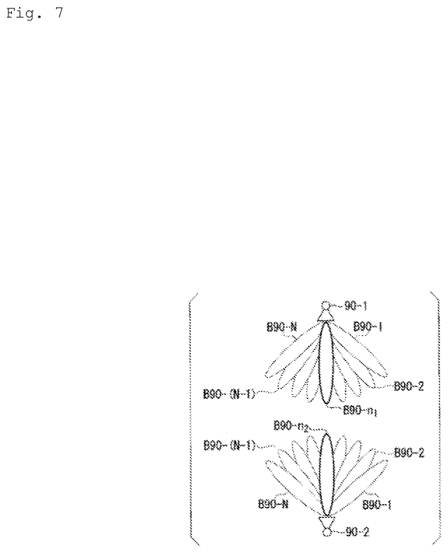

FIG. 8 is a diagram showing a wireless communication system in which a plurality of wireless communication links are set up.

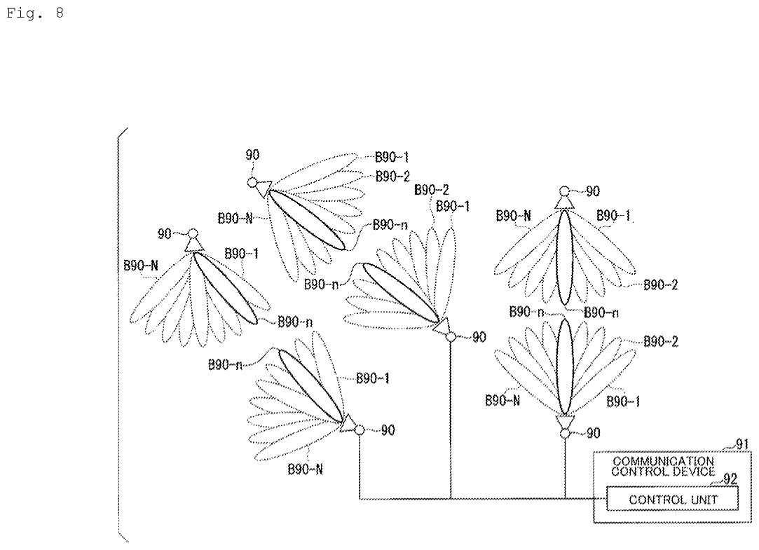

FIG. 9 is a diagram showing beams that can be formed by a wireless communication device.

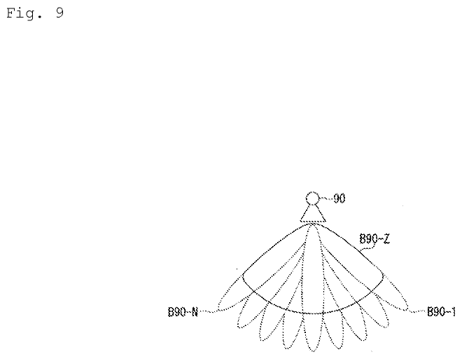

### DESCRIPTION OF EMBODIMENTS

Hereinafter, embodiments of the present invention will be described in detail with reference to the drawings. The present embodiments relate to a wireless communication device that communicates using beamforming in a high frequency band such as the millimeter wave band. In particular, the present embodiments relate to a terminal device of a wireless communication system in which a plurality of devices communicate with each other asynchronously and simultaneously at the same frequency, as in IEEE802.11ad.

During beamforming in wireless communication, the wireless communication device of the embodiments attempts to temporarily connects another wireless communication device while fixing a beam in a direction of a desired wireless communication link (which is also referred to as communication link). The wireless communication device measures signal power from the other wireless communication device through a connection sequence at this time. The measured signal power is equivalent to the interference power level that occurs between the link. That is to say, the wireless communication device can measure the interference power levels in a plurality of wireless communication links using a power measurement mechanism for use in communication. By using the thus-measured interference power level, it is possible to effectively use wireless communication resources through transmission power control and frequency allocation optimization performed while considering interference power over the entire wireless communication system. The embodiments of the present invention will be described below in detail.

### First Embodiment

In the first embodiment, a wireless communication device and another wireless communication device that is an interference measurement partner are connected to the same communication control device.

### Configuration of Present Embodiment

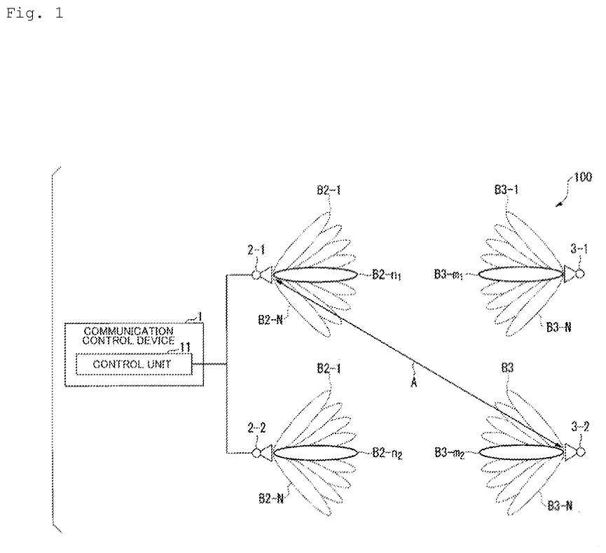

FIG. 1 is a diagram showing an example of a configuration of a wireless communication system 100 according to the first embodiment. The wireless communication system 100 has a communication control device 1, wireless communication devices 2, and wireless communication devices 3. FIG. 1 shows two wireless communication devices 2 and two wireless communication devices 3, but any number of wireless communication devices 2 and wireless communication devices 3 may be provided. An i-th (i is an integer of 1 or more) wireless communication device 2 is referred to as a wireless communication device 2-i, and an i-th (i is an integer of 1 or more) wireless communication device 3 is referred to as a wireless communication device 3-i.

The communication control device 1 is wired-connected to the wireless communication devices 2. The communication control device 1 includes a control unit 11. The control unit 11 performs control such as transmission power control and frequency allocation optimization while considering interference power in the wireless communication devices 2 and 3, in order to effectively use wireless communication resources in the wireless communication system 100. For this control, the control unit 11 gives the wireless communication devices 2 and 3 an instruction to measure interference power.

The wireless communication devices 2 and 3 are, for example, devices that communicate using beamforming in a high frequency band such as the millimeter wave band. The wireless communication devices 2 and 3 may be terminal devices that conform to IEEE802.11ad or the like and communicate with other terminal devices asynchronously and simultaneously at the same frequency. Note that the wireless communication devices 2 and 3 may alternatively be devices that perform wireless communication conforming to any other standards. The wireless communication devices 2 can perform beamforming using beams B2-1 to B2-N (N is an integer of 2 or more), and the wireless communication devices 3 can perform beamform using beams B3-1 to B3-N (N is an integer of 2 or more). Note that the value of N may differ depending on the wireless communication device 2 and the wireless communication device 3.

The wireless communication device 2-1 and the wireless communication device 3-1 form a wireless communication link by means of beamforming using beams B2-n₁ and B3-m₁ (n₁ and m₁ are integers of 1 or more and N or less), and are connected to each other. The wireless communication device 2-2 and the wireless communication device 3-2 form a wireless communication link by means of beamforming using beams B2-n₂ and B3-m₂ (n₂ and m₂ are integers of 1 or more and N or less), and are connected to each other. An arrow A in FIG. 1 indicates interference that the wireless communication device 2-1 receives from the wireless communication device 3-2 and interference that the wireless communication device 3-2 receives from the wireless communication device 2-1. In the following, the present embodiment will be described, taking as an example the case of measuring interference power of the interference indicated by the arrow A.

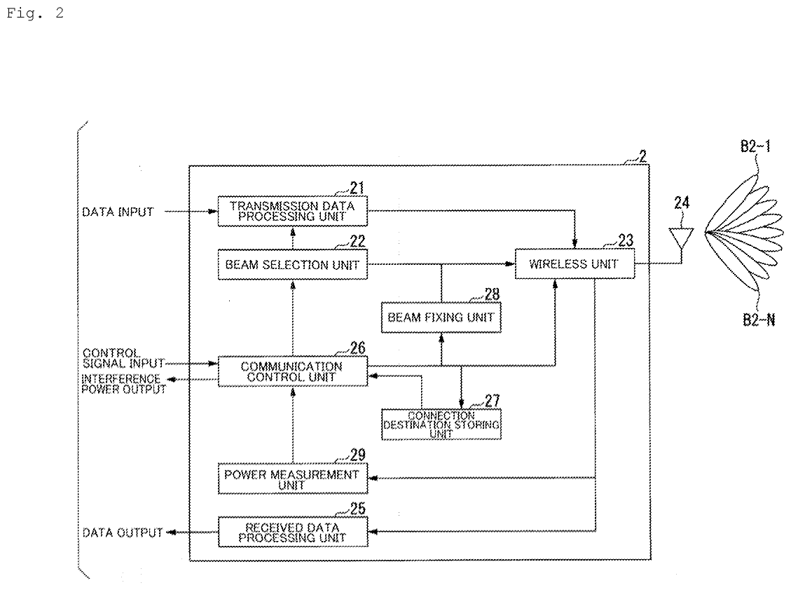

FIG. 2 is a block diagram showing a configuration of each wireless communication device 2 according to the present embodiment. The wireless communication device 2 includes a transmission data processing unit 21, a beam selection unit 22, a wireless unit 23, an antenna 24, a received data processing unit 25, a communication control unit 26, a connection destination storing unit 27, a beam fixing unit 28, and a power measurement unit 29.

The transmission data processing unit 21 receives input of data to be transmitted, from a wired connection side. The transmission data processing unit 21 generates a transmission signal on which the input data is superimposed. The transmission data processing unit 21 outputs the generated transmission signal to the wireless unit 23.

The beam selection unit 22 selects a beam to be used in communication with an opposing wireless communication device 3, which is a communication partner, from among beams B2-1 to B2-N(N is an integer of 2 or more), which are directional beams that can be formed by the wireless unit 23. The wireless unit 23 performs beamforming for a wireless signal to be transmitted from the antenna 24. The wireless unit 23 establishes a wireless communication link with the opposing wireless communication device 3 using a beam B2-n (n is an integer of 1 or more and N or less) selected by the beam selection unit 22. The wireless unit 23 transmits and receives the wireless signal over the established wireless communication link. That is to say, the wireless unit 23 up-converts the transmission signal generated by the transmission data processing unit 21 to convert the signal from an electrical signal to a wireless signal, and wirelessly transmits the transmission signal from the antenna 24. Further, the wireless unit 23 down-converts a received signal that is wirelessly received by the antenna 24 to convert the signal to an electrical signal, and outputs the received signal converted to an electrical signal to the received data processing unit 25.

The received data processing unit 25 receives input of the received signal from the wireless unit 23. The received data processing unit 25 acquires data superimposed on the receive signal, and outputs the acquired data to the wired connection side.

The communication control unit 26 receives a control signal from the communication control device 1. The communication control unit 26 controls each unit in accordance with the control signal. The communication control unit 26 also outputs, to the wireless unit 23, a control signal that is received from the communication control device 1 and addressed to the wireless communication device 3. Thus, the wireless unit 23 wirelessly transmits the control signal addressed to the wireless communication device 3. The control signal includes an interference measurement instruction from the communication control device 1. When acquiring the interference measurement instruction from the control signal, the communication control unit 26 gives the beam fixing unit 28 an instruction to fix the currently used beam. Furthermore, the communication control unit 26 gives the wireless unit 23 an instruction to attempt processing for connect to a measurement target device indicated by the instruction from the communication control device 1. The measurement target device is a wireless communication device 3 that can cause interference. The communication control unit 26 receives, from the power measurement unit 29, a measured value of interference power from the measurement target device connected through this connection processing. The communication control unit 26 transmits the measured value of the interference power to the communication control device 1.

The connection destination storing unit 27 stores information regarding the wireless communication device 3 that is the communication partner with which a wireless communication link has been configured before the interference measurement. The beam fixing unit 28 transmits a beam fixing instruction to the wireless unit 23 based on an instruction from the communication control unit 26. The power measurement unit 29 measures signal power of a wireless signal received by the wireless unit 23, and outputs a measured value of the signal power to the communication control unit 26.

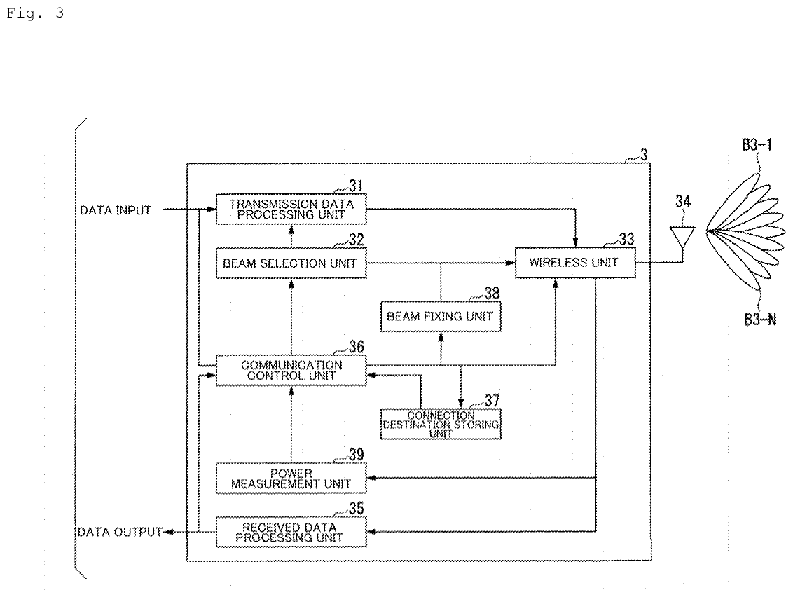

FIG. 3 is a block diagram showing a configuration of each wireless communication device 3 according to the present embodiment. The wireless communication device 3 includes a transmission data processing unit 31, a beam selection unit 32, a wireless unit 33, an antenna 34, a received data processing unit 35, a communication control unit 36, a connection destination storing unit 37, a beam fixing unit 38, and a power measurement unit 39. The transmission data processing unit 31, the beam selection unit 32, the wireless unit 33, the antenna 34, the received data processing unit 35, the communication control unit 36, the connection destination storing unit 37, the beam fixing unit 38, and the power measurement unit 39 respectively have the same functions as the transmission data processing unit 21, the beam selection unit 22, the wireless unit 23, the antenna 24, the received data processing unit 25, the communication control unit 26, the connection destination storing unit 27, the beam fixing unit 28, and the power measurement unit 29 that are included in the wireless communication device 2 shown in FIG. 1.

However, the wireless unit 33 can form directional beams, namely beams B3-1 to B3-N (N is an integer of 2 or more). The wireless unit 33 establishes a wireless communication link with the opposing wireless communication device 2 that is the communication partner, using a beam B3-n (n is an integer of 1 or more and N or less) selected by the beam selection unit 32.

The communication control unit 36 receives input of a control signal received from the wireless communication device 2. That is to say, the wireless communication device 3 is connected to the communication control device 1 via the wireless communication link with the opposing wireless communication device 2, unlike the wireless communication device 2. For this reason, the received data processing unit 35 acquires a control signal from a wireless signal received by the wireless unit 33 over the wireless communication link with the wireless communication device 2 that is the communication partner, and outputs the acquired control signal to the communication control unit 36. Upon receiving an interference measurement instruction from the communication control device 1 that is included in the control signal, the communication control unit 36 gives the beam fixing unit 38 to fix the currently used beam. Then, the communication control unit 36 gives the wireless unit 33 an instruction to attempt processing for connecting to a measurement target device indicated by the instruction from the communication control device 1. The measurement target device is a wireless communication device 2 that can cause interference. After receiving, from the power measurement unit 39, a measured value of interference power from the measurement target device connected trough the connection processing, the communication control unit 36 gives the wireless unit 33 an instruction to reconnect to the wireless communication link with the wireless communication device 2 that is the communication partner. After the reconnection, the communication control unit 36 wirelessly transmits the measured value of the interference power from the wireless unit 33. The wireless communication device 2 that is the communication partner transmits the measured value of the interference power to the communication control device 1.

### Operation of the Present Embodiment

It is assumed in the description of the present embodiment that a wireless communication device 2 and an opposing wireless communication device 3 have been connected, a beam that maximizes received power has been selected, and a wireless communication link has been established, in advance, by a link establishment procedure in any method such as IEEE802.11ad. In each wireless communication device 2, the transmission data processing unit 21 receives input of data from the wired connection side. The wireless unit 23 transfers the data input to the transmission data processing unit 21 to the opposing wireless communication device 3 over the wireless communication link established using the beam selected by the beam selection unit 22. The wireless unit 23 also outputs the data received over the wireless communication link to the received data processing unit 25. The received data processing unit 25 outputs the data input from the wireless unit 23 to the wired connection side.

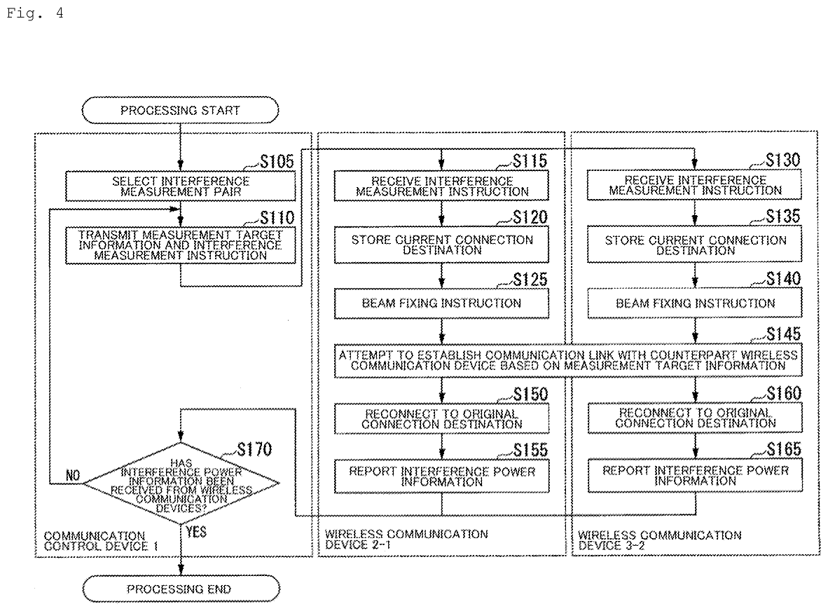

FIG. 4 is a flowchart showing operations of the wireless communication system 100 according to the present embodiment. Operations of the control unit 11 of the communication control device 1, the communication control unit 26 of the wireless communication device 2-1, and the communication control unit 36 of the wireless communication device 3-2 will be described with reference to FIG. 4.

First, the control unit 11 of the communication control device 1 selects a pair of wireless communication devices with which interference measurement is to be performed (step S105). Here, a description will be given of an example where the pair of the wireless communication device 2-1 and the wireless communication device 3-2 has been selected as previously mentioned. At this time, the control unit 11 transmits measurement target information indicating the counterpart wireless communication device with which interference measurement is to be performed, and an interference measurement instruction to the communication control unit 26 of the wireless communication device 2-1 and the communication control unit 36 of the wireless communication device 3-2 (step S110). The measurement target information transmitted to the communication control unit 26 of the wireless communication device 2-1 indicates information regarding the wireless communication device 3-2, and the measurement target information transmitted to the communication control unit 36 of the wireless communication device 3-2 indicates information regarding the wireless communication device 2-1. The measurement target information includes information to be used to establish a link, such as information for identifying the counterpart wireless communication device with which interference measurement is to be performed. In the present embodiment, the control unit 11 transmits the interference measurement instruction and the measurement target information in association with each other by, for example, adding the measurement target information to the interference measurement instruction.

Upon receiving the interference measurement instruction addressed to the wireless communication device 2-1 from the communication control device 1 (step S115), the communication control unit 26 of the wireless communication device 2-1 stores information for identifying the currently connected wireless communication device 3-1 in the connection destination storing unit 27 (step S120). Then, the communication control unit 26 transmits a beam fixing instruction to the wireless unit 23 via the beam fixing unit 28 (step S125). The wireless unit 23 fixes the beam to the beam B2-n₁ that is used for the wireless communication link with the wireless communication device 3-1.

Meanwhile, the communication control unit 26 of the wireless communication device 2-2 outputs, to the wireless unit 23, the interference measurement instruction that is received from the communication control device 1 and addressed to the wireless communication device 3-2. The wireless unit 23 wirelessly transmits the interference measurement instruction from the antenna 24. The received data processing unit 35 of the wireless communication device 3-2 acquires the interference measurement instruction from the wireless signal received by the wireless unit 33, and outputs the acquired interference measurement instruction to the communication control unit 36 (step S130). Upon receiving the interference measurement instruction from the received data processing unit 35, the communication control unit 36 stores the information for identifying the wireless communication device 2-2, which is the current connection destination, in the connection destination storing unit 37 (step S135). Then, the communication control unit 36 transmits a beam fixing instruction to the wireless unit 33 via the beam fixing unit 38 (step S140). The wireless unit 33 fixes the beam to the beam B3-m₂ that is used for the wireless communication link with the wireless communication device 2-2.

As a result of the above operations, the wireless communication device 2-1 fixes the beam oriented toward the wireless communication device 3-1, and the wireless communication device 3-2 fixes the beam oriented toward the wireless communication device 2-2. Furthermore, the communication control unit 26 of the wireless communication device 2-1 attempts to establish a wireless communication link alternately with the counterpart wireless communication device 3-2 based on the measurement target information received from the communication control device 1. Similarly, the communication control unit 36 of the wireless communication device 3-2 attempts to establish a wireless communication link alternately with the wireless communication device 2-1 based on the measurement target information received together with the interference measurement instruction from the communication control device 1 (step S145).

When the wireless communication link is established, the wireless communication device feeds back received power at the receiving station to the transmitting station for the purpose of adaptive modulation. For this reason, although the beams are not moved by instructions from the beam fixing units 28 and 38, the power measurement unit 29 of the wireless communication device 2-1 measures received power at the wireless unit 23, and the power measurement unit 39 of the wireless communication device 3-2 measures received power at the wireless unit 33. That is to say, the wireless communication device 2-1 can ascertain the received power of a signal transmitted from the wireless communication device 3-2, and the wireless communication device 3-2 can ascertain the received power of a signal transmitted from the wireless communication device 2-1. The measured received power is completely equivalent to interference power that the wireless communication device 2-1 receives from the wireless communication device 3-2 and interference power that the wireless communication device 3-2 receives from the wireless communication device 2-1 during communication performed over the original wireless communication links (the wireless communication link between the wireless communication device 2-1 and the wireless communication device 3-1 and the wireless communication link between the wireless communication device 2-2 and the wireless communication device 3-2). Therefore, the following description will be given, assuming that the above received power is interfering power.

Note that a configuration may also be employed in which the power measurement units 29 and 39 have a timer for a certain period during the power measurement, and the received power is regarded as being 0 if no signal is received within this period. The following description will be given based on the premise that the signal is received and the received power can be measured. However, when no signal is received, the operations of the present embodiment is not affected even if processing is performed while regarding the received power as being 0.

After the power measurement unit 29 has completed the power measurement, the communication control unit 26 of the wireless communication device 2-1 reconnects to the original connection destination stored in the connection destination storing unit 27 and gives the wireless unit 23 an instruction to restore the wireless communication link. The wireless unit 23 restores the wireless communication link with and reconnects to the wireless communication device 3-1 in accordance with the instruction from the communication control unit 26 (step S150). Upon the link being restored, the communication control unit 26 reports, to the communication control device 1, interference power information indicating the value of the interference power measured by the power measurement unit 29 (step S155).

Similarly, after the power measurement unit 39 has completed power measurement, the communication control unit 36 of the wireless communication device 3-2 gives the wireless unit 33 an instruction to reconnect to the original connection destination stored in the connection destination storage unit 37 and restore the wireless communication link. The wireless unit 33 restores the wireless communication link with and reconnects to the wireless communication device 2-2 in accordance with the instruction from the communication control unit 36 (step S160). Upon the link being restored, the communication control unit 36 reports, to the communication control device 1, interference power information indicating the value of the interference power measured by the power measurement unit 39 (step S165). That is to say, the communication control unit 36 controls the wireless unit 33 so as to wirelessly transmit the interference power information using the restored wireless communication link. The received data processing unit 25 of the wireless communication device 2-2 transmits, to the communication control device 1, the interference power information that is wirelessly received by the wireless unit 23 from the wireless communication device 3-2.

The control unit 11 of the communication control device 1 determines whether or not the interference power information has been received from both wireless communication devices 2 and 3 to which the interference measurement instruction has been transmitted (step S170). If it is determined that the interference power information corresponding to the respective interference measurement instructions transmitted have not arrived (step S170: NO), the control unit 11 returns to the processing in step S110 and transmits the interference measurement instruction again to the relevant wireless communication device(s) 2 and/or 3.

If it is determined that the interference power information has been received from both wireless communication devices 2 and 3 to which the interference measurement instruction has been transmitted, i.e., the interference power information has arrived (step S170: YES), desired interference power information has been obtained, and therefore the control unit 11 of the communication control device 1 ends the processing in FIG. 4. Note that, thereafter, the control unit 11 may also collect interference power information between other wireless communication devices. Further, the control unit 11 may also control transmission power of the wireless communication devices 2 and 3 and change the frequency such that wireless communication resources in the space can be fully used, based on the obtained interference power information. Although such processing is conceivable, the present embodiment can be combined with any method, and the description thereof is omitted accordingly.

The embodiment of the present invention has been described while taking, as an example, the case of measuring interference power between the wireless communication device 2 that is wired-connected to the communication control device 1 and the wireless communication device 3 that is connected to the communication control device 1 via the wireless communication link. However, measurement of interference power between the wireless communication devices 2 that are wired-connected to the communication control device 1 or between the wireless communication devices 3 that are connected to the communication control device 1 via wireless communication links is also essentially the same, and therefore the present embodiment is similarly applicable to such interference power measurement.

The present embodiment has been described while taking, as an example, a one-to-one configuration in which a wireless communication link is configured between one wireless communication device 2 and one wireless communication device 3. However, the present embodiment is similarly applicable to the case of a one-to-many wireless communication link, such as the case where either one of the wireless communication devices 2 and 3 has an access point function in a wireless LAN.

Although the above description has been given while taking, as an example, the case where the communication control device 1 and the wireless communication device 2 are wired-connected, the communication control device 1 and the wireless communication device 2 may alternatively be wirelessly connected. In this case, the wireless communication device 2 may have a second wireless unit that wirelessly communicates with the communication control device 1 using a wireless communication method that is the same as or different from that of the wireless unit 23. The second wireless unit of the wireless communication device 2 wirelessly receives the interference measurement instruction and the measurement target information from the communication control device 1, and wirelessly transmits the interference power information to the communication control device 1.

### Second Embodiment

In the first embodiment, a wireless communication device and another wireless communication device that is an interference measurement partner are connected to the same communication control device. However, the wireless communication device that is an interference measurement partner does not necessarily need to be connected to the communication control device. The present embodiment will describe the case where a wireless communication device that is an interference measurement partner of a wireless communication device connected to the communication control device is not connected to the same communication control device. In the following, differences from the first embodiment will be described mainly.

### Configuration of Embodiment

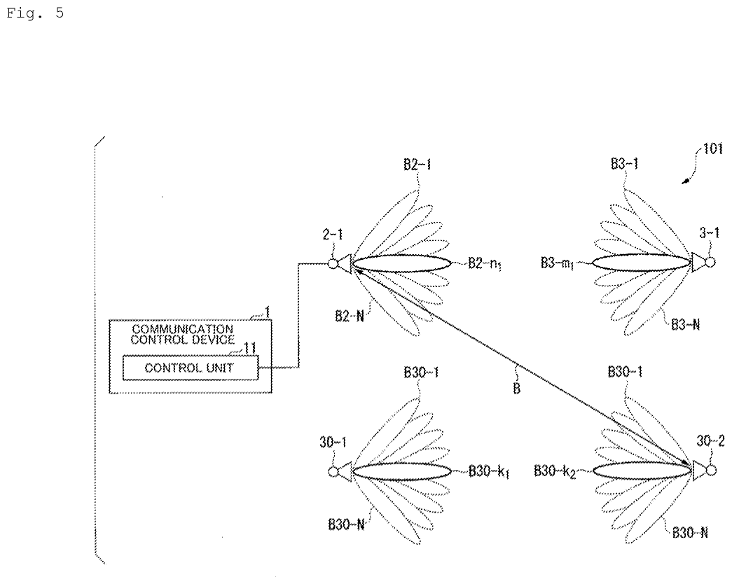

FIG. 5 is a diagram showing an example of a configuration of a wireless communication system 101 according to the second embodiment. In FIG. 5, the same portions as those of the wireless communication system 100 according to the first embodiment shown in FIG. 1 are assigned the same reference numerals, and the description thereof is omitted. The wireless communication system 101 has a communication control device 1, a wireless communication device 2, a wireless communication device 3, and wireless communication devices 30. An i-th (i is an integer of 1 or more) wireless communication device 30 is referred to as a wireless communication device 30-i. FIG. 5 shows a wireless communication device 2-1 that is the first wireless communication device 2, a wireless communication device 3-1 that is the first wireless communication device 3, and wireless communication devices 30-1 and 30-2 that are the first and second wireless communication devices 30, but any number of wireless communication devices 2, wireless communication devices 3, and wireless communication devices 30 may be provided.

In the present embodiment, the wireless communication devices 30-1 and 30-2 that correspond to the wireless communication devices 2-2 and 3-2 of the first embodiment are not covered by the communication control device 1. In this case as well, if the wireless communication devices 30-1 and 30-2 has the same beam fixing function as that of the first embodiment, the wireless communication devices 2 and 3 can ascertain interference power received from the wireless communication devices 30-1 and 30-2.

The wireless communication device 30 can perform beamforming using directional beams, namely beams B30-1 to B30-N (N is an integer of 2 or more). The value of N may differ depending on the wireless communication device 30. The wireless communication devices 2-1 and 3-1 form a wireless communication link by means of beamforming using beams B2-n₁ and B3-m₁ (n₁ and m₁ are integers of 1 or more and N or less), and are connected to each other. The wireless communication devices 30-1 and 30-2 form a wireless communication link by means of beamforming using beams B30-k₁ and B30-k₂ (k₁ and k₂ are integers of 1 or more and N or less), and are connected to each other. An arrow B in FIG. 5 indicates interference that the wireless communication device 2-1 receives from the wireless communication device 30-2 and interference that the wireless communication device 30-2 receives from the wireless communication device 2-1. In the following, the present embodiment will be described while taking, as an example, the case of measuring interference power of the interference indicated by the arrow B.

The block diagram that shows the configuration of the wireless communication device 2 of the present embodiment is the same as the block diagram of the first embodiment shown in FIG. 2. The block diagram of the wireless communication device 30 is the same as the wireless communication device 3 of the first embodiment shown in FIG. 3.

### Operation of Embodiment

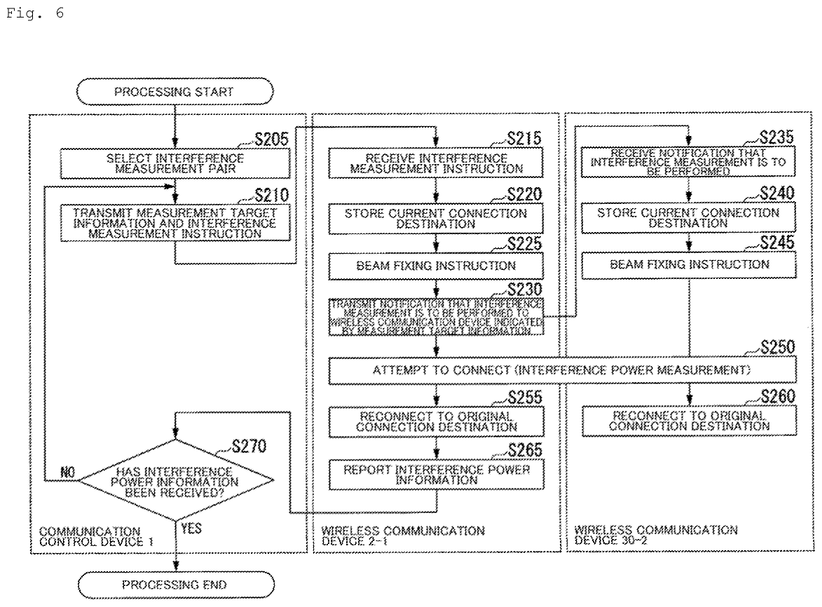

FIG. 6 is a flowchart showing operations of the wireless communication system 101 according to the present embodiment. Operations of the control unit 11 of the communication control device 1, the communication control unit 26 of the wireless communication device 2-1 and the communication control unit 36 of the wireless communication device 30-2 will be described with reference to FIG. 6.

First, the control unit 11 of the communication control device 1 selects a pair of wireless communication devices with which interference measurement is to be performed (step S205). Here, a description will be given of an example where the pair of the wireless communication device 2-1 and the wireless communication device 30-2 has been selected as previously mentioned. At this time, the control unit 11 transmits measurement target information indicating the counterpart wireless communication device 30-2 with which interference measurement is to be performed, and an interference measurement instruction, in association with each other, to the communication control unit 26 of the wireless communication device 2-1 covered by the communication control device 1 (step S210).

Upon receiving the interference measurement instruction from the communication control device 1 (step S215), the communication control unit 26 of the wireless communication device 2-1 stores information for identifying the currently connected wireless communication device 3-1 in the connection destination storing unit 27 (step S220). Then, the communication control unit 26 transmits a beam fixing instruction to the wireless unit 23 via the beam fixing unit 28 (step S225). The wireless unit 23 fixes the beam to the beam B2-n₁ that is used for the wireless communication link with the wireless communication device 3-1.

Further, the communication control unit 26 transmits an interference measurement notification that interference measurement is to be performed, from the wireless unit 23 to the counterpart wireless communication device 3-2 with which interference measurement is to be performed indicated by the measurement target information received from the communication control device 1 (step S230). Although a wireless communication link is not established between the wireless communication device 2-1 and the wireless communication device 30-2, the interference measurement notification can be transmitted to the wireless communication device 30-2 by using a notification signal that is broadcast over the entire communication area, such as a beacon signal in IEEE802.11ad, for example.

The received data processing unit 35 of the wireless communication device 30-2 acquires the interference measurement notification from the wireless signal received by the wireless unit 33, and outputs the acquired interference measurement notification to the communication control unit 36 (step S235). Upon receiving the interference measurement notification from the received data processing unit 35, the communication control unit 36 of the wireless communication device 30-2 stores information for identifying the wireless communication device 30-1, which is the current connection destination, in the connection destination storing unit 37 (step S240). Then, the received data processing unit 35 of the wireless communication device 30-2 transmits a beam fixing instruction to the wireless unit 33 via the beam fixing unit 38 (step S245). The wireless unit 33 of the wireless communication device 30-2 fixes the beam to the beam B30-k₂ that is used for the wireless communication link with the wireless communication device 30-1.

As a result of the above operations, the wireless communication device 2-1 fixes the beam oriented toward the wireless communication device 3-1, and the wireless communication device 30-2 fixes the beam oriented toward the wireless communication device 30-1. Furthermore, the communication control unit 26 of the wireless communication device 2-1 attempts to establish a wireless communication link with the partner wireless communication device 30-2 based on the measurement target information received from the communication control device 1 (step S250). When the wireless communication link is established, the beam is not moved by the instruction from the beam fixing unit 28, but the power measurement unit 29 of the wireless communication device 2-1 measures signal power received by the wireless unit 23 from the wireless communication device 30-2 for the purpose of adaptive modulation. Thus, interference power received by the wireless communication device 2-1 can be measured when the wireless communication device 30-2 directs the beam to the wireless communication device 30-1.

Note that a configuration may be employed in which the power measurement units 29 has a timer for a certain period during the power measurement, and the received power is regarded as being 0 if no signal is received within this period. The following description will be given based on the premise that the signal is received and the received power can be measured. However, when no signal is received, the operations of the present embodiment is not affected even if processing is performed while regarding the received power as being 0.

After the power measurement unit 29 has completed the power measurement, the communication control unit 26 of the wireless communication device 2-1 reconnects to the original connection destination stored in the connection destination storing unit 27 and gives the wireless unit 23 to restore the wireless communication link. The wireless unit 23 restores the wireless communication link with and reconnects to the wireless communication device 3-1 in accordance with the instruction from the communication control unit 26 (step S255).

Similarly, after the power measurement has been completed, the communication control unit 36 of the wireless communication device 30-2 gives the wireless unit 33 an instruction to reconnect to the original connection destination stored in the connection destination storage unit 37 and restore the wireless communication link. For example, the wireless communication device 2-1 broadcasts the completion of the power measurement by means of a notification signal. The received data processing unit 35 of the wireless communication device 30-2 acquires information indicating that the power measurement has been completed from the notification signal received by the wireless unit 33, and outputs the acquired information to the communication control unit 36. Alternatively, the communication control unit 36 of the wireless communication device 30-2 may consider that the power measurement has been completed based on a predetermined period having been elapsed since the reception of the interference measurement notification. The wireless unit 33 of the wireless communication device 30-2 restores the wireless communication link with the wireless communication device 30-1 and reconnects thereto in accordance with an instruction from the communication control unit 36 (step S260). Further, the communication control unit 26 of the wireless communication device 2-1 reports, to the communication control device 1, interference power information indicating the value of the interference power measured by the power measurement unit 29 (step S265).

The control unit 11 of the communication control device 1 determines whether or not the interference power information from the wireless communication device 2-1 has been received (step S270). If it is determined that the interference power information has not been received from the wireless communication device 2-1 (step S270: NO), the control unit 11 returns to the processing in step S210 and transmits the interference measurement instruction again to the wireless communication device 2-1.

If it is determined that the interference power information has been received from the wireless communication device 2-1 (step S270: YES), desired interference power information has been obtained, and thus the control unit 11 of the communication control device 1 ends the processing in FIG. 6. Note that, in the case of the time division multiplexing (TDD) method in which the same frequency is used for transmission and reception, the reciprocity of wireless transmission paths holds. Accordingly, the interference power received by the wireless communication device 2-1 is equivalent, as-is, to the interference power that the wireless communication device 30-2 receives from the wireless communication device 2-1.

Also, thereafter, the control unit 11 of the communication control device 1 may also collect interference power information between other wireless communication devices. Further, the control unit 11 may also control transmission power of the wireless communication devices 2 and 3 and change the frequency such that wireless communication resources in the space can be fully used, based on the obtained interference power information. Although such processing is conceivable, the present embodiment can be combined with any method, and the description thereof is omitted accordingly.

The present embodiment has been described while taking, as an example, the case where the wireless communication device 2 that is wired-connected to the communication control device 1 measures interference power from the wireless communication device 30 that is not connected to the communication control device 1. However, measurement of interference power from the wireless communication device 3 that is connected to the communication control device 1 via a wireless communication link is also essentially the same, and therefore the present embodiment is similarly applicable thereto.

Further, the present embodiment has been described while taking, as an example, a one-to-one configuration in which a wireless communication link is configured between one wireless communication device 2 and one wireless communication device 30. However, the present embodiment can be similarly applied to the case of a one-to-many wireless communication link, such as the case where either one of the wireless communication devices 2 and 30 has an access point function in a wireless LAN.

The first and second embodiments have been described above while taking two-dimensional drawings as an example, but the above-described embodiments is also similarly applicable to wireless communication devices that perform three-dimensional beamforming.

According to the above-described embodiments, a wireless communication device that performs beamforming can measure interference power received from another wireless communication device that may be an interference source, using a power measurement index used in a normal wireless connection sequence, in a state where the wireless communication device fixes a beam toward an opposing wireless communication device that is a communication partner. Accordingly, interference power received by a wireless communication link can be accurately ascertained without providing an additional interference power measurement circuit or the like. Accordingly, wireless communication resources can be effectively used through transmission power control and frequency allocation optimization.

Note that some of the functions of the communication control device 1 and the wireless communication devices 2, 3, and 30 of the above-described embodiments may be realized by a processor such as a CPU (central processing unit) loading and executing a program from a storage unit. Some of the functions of the communication control device 1 and the wireless communication devices 2, 3, and 30 may be realized by using hardware such as an ASIC (Application Specific Integrated Circuit), a PLD (Programmable Logic Device), or an FPGA (Field Programmable Gate Array).

According to the above embodiments, the wireless communication system has a communication control device and a plurality of wireless communication devices. The communication control device includes a control unit. The control unit transmits, to one of the wireless communication devices, information regarding a measurement target device, which is another one of the wireless communication devices with which interference power is to be measured.

Each of the wireless communication devices has a wireless unit, a power measurement unit, and a communication control unit. The wireless unit performs processing for forming a beam and transmitting and receiving a wireless signal using the formed beam. The power measurement unit measures power of a wireless signal received by the wireless unit. The communication control unit performs processing for controlling the wireless unit so as to establish a second wireless communication link with the measurement target device using a beam for a first wireless communication link, and processing for controlling the power measurement unit so as to measure power of a wireless signal received from the measurement target device when establishing the second wireless communication link.

The first wireless communication link is a communication link between one of the wireless communication devices and another one of the wireless communication devices that is a communication partner of the one of the wireless communication devices. The first wireless communication link may be established before the processing for establishing the second wireless communication link. After measuring power of the wireless signal received from the measurement target device, the communication control unit of one of the wireless communication devices may control the wireless unit so as to connect to a wireless communication device that is a communication partner of the one of the wireless communication devices over the first wireless communication link.

Note that the communication control unit of each of the wireless communication devices may receive the information regarding the measurement target device from the communication control device in a wired manner, or may wirelessly receive the information using a second wireless unit included in the wireless communication device, or may wirelessly receive the information via a wireless communication device that is a communication partner.

The communication control unit of each of the wireless communication devices that has received the information regarding the measurement target device from the communication control device may control the wireless unit so as to wirelessly transmit an interference measurement notification that interference measurement is to be performed, to the measurement target device. If the interference measurement notification is received, the communication control unit of the measurement target device controls the wireless unit so as to transmit a wireless signal using a beam formed for a wireless communication link between the measurement target device and the wireless communication device that is the communication partner.

Although the embodiments of the present invention have been described above in detail with reference to the drawings, specific configurations are not limited to these embodiments and also include designs or the like made without departing from the gist of the invention.

### REFERENCE SIGNS LIST

1, 91 Communication control device
2, 2-1, 2-2, 3, 3-1, 3-2, 30-1, 30-2, 90-1, 90-2 Wireless communication device
21, 31 Transmission data processing unit
22, 32 Beam selection unit
23, 33 Wireless unit
24, 34 Antenna
25, 35 Received data processing unit
26, 36 Communication control unit
27, 37 Connection destination storing unit
28, 38 Beam fixing unit
29, 39 Power measurement unit
11, 92 Control unit
100, 101 Wireless communication system

1. A wireless communication system that has a communication control device and a plurality of wireless communication devices,
the communication control device comprising
a control unit for transmitting, to one of the wireless communication devices, information regarding a measurement target device, which is another one of the wireless communication devices with which interference power is to be measured, and
each of the wireless communication devices comprising:
a wireless unit for forming a beam and transmitting and receiving a wireless signal using the formed beam;
a power measurement unit for measuring power of a wireless signal received by the wireless unit; and
a communication control unit for performing processing for controlling the wireless unit so as to establish a second wireless communication link with the measurement target device using a beam for a first wireless communication link, and processing for controlling the power measurement unit so as to measure power of a wireless signal received from the measurement target device when establishing the second wireless communication link.

2. The wireless communication system according to claim 1,
wherein the first wireless communication link is established before the processing for establishing the second wireless communication link.

3. The wireless communication system according to claim 1,
wherein, after measuring power of the wireless signal received from the measurement target device, the communication control unit controls the wireless unit so as to connect to a wireless communication device that is a communication partner over the first wireless communication link.

4. The wireless communication system according to claim 1,
wherein the communication control unit receives the information regarding the measurement target device from the communication control device in a wired or wireless manner, or wirelessly via a wireless communication device that is a communication partner.

5. The wireless communication system according to claim 1,
wherein the communication control unit of the wireless communication device that has received the information regarding the measurement target device from the communication control device controls the wireless unit so as to wirelessly transmit an interference measurement notification that interference measurement is to be performed, to the measurement target device, and
if the interference measurement notification is received, the communication control unit of the measurement target device controls the wireless unit so as to transmit a wireless signal using a beam that has been formed when the interference measurement notification was received.

6. A wireless communication device comprising:
a wireless unit for forming a beam and transmitting and receiving a wireless signal using the formed beam;
a power measurement unit for measuring power of a wireless signal received by the wireless unit; and
a communication control unit for performing processing for receiving information regarding a measurement target device that is a wireless communication device with which interference power is to be measured and controlling the wireless unit so as to establish a second wireless communication link with the measurement target device using a beam for a first wireless communication link, and processing for controlling the power measurement unit so as to measure power of a wireless signal received from the measurement target device when establishing the second wireless communication link.

7. A wireless communication method for use in a wireless communication system that has a communication control device and a plurality of wireless communication devices, the method comprising:
a transmission step of transmitting, to one of the wireless communication devices, information regarding a measurement target device that is another one of the wireless communication devices with which interference power is to be measured, with use of the communication control device;
a wireless communication step of forming a beam and transmitting and receiving a wireless signal using the formed beam, with use of a wireless unit of the one of the wireless communication devices;
a power measurement step of measuring power of a wireless signal received by the wireless unit, with use of a power measurement unit of the one of the wireless communication devices; and
a communication control step of performing processing for controlling the wireless unit so as to establish a second wireless communication link with the measurement target device using a beam for a first wireless communication link, and processing for controlling the power measurement unit so as to measure power of a wireless signal received from the measurement target device when establishing the second wireless communication link, with use of a communication control unit of the wireless communication device.
